(19) United States
(12) Patent Application Publication
(10) Pub. No.: US 2026/0111677 A1
(43) Pub. Date: Apr. 23, 2026

(54) System and Method for Automatic Data-Type Detection

(71) Applicant: LiveRamp, Inc., San Francisco, CA (US)

(72) Inventors: Jaipal Nenavath, Hyderabad (IN); Jayakumar Reddy Attur, Hyderabad (IN); Putty Vikas, Sangareddy (IN); Shirish Kumar, Sunnyvale, CA (US)

(21) Appl. No.: 19/114,195

(22) PCT Filed: Oct. 2, 2023
(86) PCT No.: PCT/US2023/075665

§ 371 Date: Mar. 21, 2025

Related U.S. Application Data
(60) Provisional application No. 63/413,077, filed on Oct. 4, 2022.

(51) Int. Cl. G06F 40/30; G06F 40/284; G06F 40/295; G06N 3/08

(52) U.S. Cl. CPC G06F 40/30; G06F 40/284; G06F 40/295; G06N 3/08

(57) ABSTRACT

A system and method utilizes masked language models in order to provide data-type detection, such as (but not limited to) prediction of columnar headings. Two masked language models are pre-trained on example columnar text. One model predicts missing data at the entity level (e.g., masked entity names that may be made up of whole words), while the other predicts missing data at the character level (e.g., masked individual characters). The table with missing column headings is fed into both models, and the output is contextual word embeddings and contextual character embeddings. These results are merged, and then fed into a neural network classifier to then predict the column names.

### CROSS-REFERENCE TO RELATED APPLICATIONS

This application claims the benefit of U.S. provisional patent application no. 63/413,077, filed on Oct. 4, 2023. Such application is incorporated herein by reference in its entirety.

### BACKGROUND

In many real-world applications, data may be received for processing without the additional information that provides necessary context or meaning for this data. For example, data may be received in a columnar table format, but the column headings are not included. In order for the data to be useful in this particular example, the column heading information must be somehow acquired. Typically, column headings are added by humans who review the data and derive context by looking at the content and format of the information in each column. The requirement of human interaction, however, slows the process of utilizing the data and increases the cost associated with its use.

The prior art does include attempts to automate the assignment of column headings based only on the content of the columns. The 2019 Sherlock project uses a neural network approach to solve this problem. The system is trained on a large repository of columnar data, and each matched column is characterized with a large grouping of features describing statistical properties, character distributions, word embeddings, and paragraph vectors of column values. An extension of the Sherlock project is the 2020 Sato model, which is also a machine-learning model trained on a large corpus of data tables. Sato uses a top-aware single-column prediction module as well as a structured output prediction module. Sato extends the Sherlock project by incorporating the concept of table intent into the single-column prediction, and then combines the topic-aware results for all columns in the structured output prediction module.

Although approaches such as Sherlock and Sato have provided promising results in machine-learning approaches for data-type detection, improvements in the accuracy of these approaches is desirable. Such improvements would aid in the processing of input data that arrives without context, such as columnar headings. In particular, although Sato improves on Sherlock by using table context across columns, it works only on known column-heading types. The inventors hereof have recognized that a process that can manage previously unknown column-heading types, for example, would be highly desirable and greatly expand the applications of such technology.

References mentioned in this background section are not admitted to be prior art with respect to the present invention.

### SUMMARY

The present invention is directed to a system and method utilizing masked language models in order to provide data-type detection, such as (but not limited to) prediction of columnar headings. Language models are a technique of natural language processing (NLP) that are trained from large data sets to understand an input word/sentence and predict an output word or sentence. Masked language models are a class of language models that are trained on a corpus of data by masking certain words in the input data and predicting the same sentence back. This helps to learn the context of the word better. The invention, in various embodiments, uses this technique in systems and methods for supplying missing column headings. In an embodiment, two masked language models are pre-trained on example columnar text. One model predicts missing data at the entity level (e.g., masked entity names that may be made up of whole words), while the other predicts missing data at the character level (e.g., masked individual characters). The table with missing column headings is fed into both models, and the output is contextual word embeddings and contextual character embeddings. These results are merged, then fed into a neural network classifier to then predict the column names.

These and other features, objects and advantages of the present invention will become better understood from a consideration of the following detailed description of the preferred embodiments and appended claims in conjunction with the drawings as described following:

### DRAWINGS

FIG. 1 is a flow diagram illustrating a method according to an embodiment of the present invention.

FIG. 2 is a table of values as an example input according to an embodiment of the present invention.

FIG. 3 is a pretrained masked language model for entities according to an embodiment of the present invention.

FIG. 4 is a pretrained masked language model for individual characters according to an embodiment of the present invention.

FIG. 5 is a table with column headings as an example output according to an embodiment of the present invention.

FIG. 6 is a hardware schematic for a computer system to implement a method according to an embodiment of the present invention.

### DETAILED DESCRIPTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

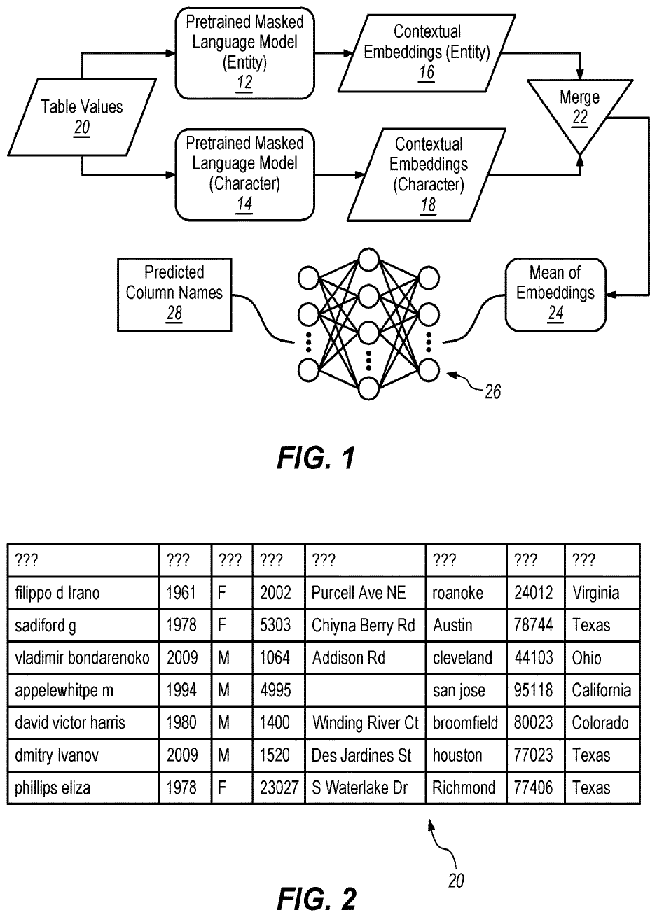

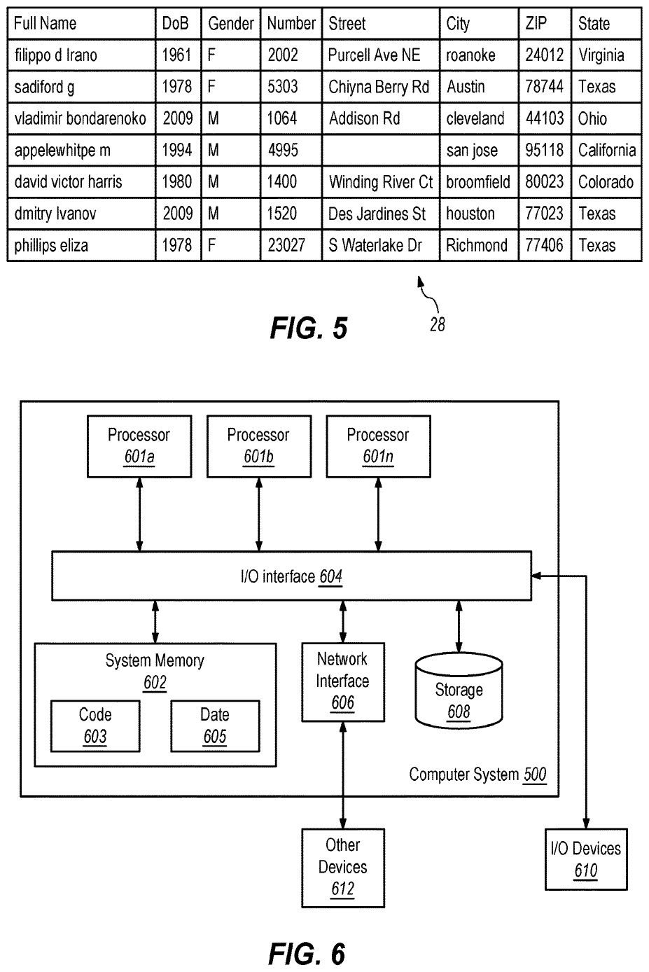

A method according to an embodiment of the present invention, using the non-limiting example of columnar data, may now be described with reference to the FIGS. 1-5. It will be understood, however, that the invention could be used on other types of data where data-type information is missing.

Table 20 represents a set of input data in a columnar format. Each row represents a particular entity (such as a person), with various fields that describe such a person. Each column contains the same fields across multiple entities. For example, a column may contain names, street address, city, state, postal code, and the like. In the example of table 20, however, the actual column headings are unknown. These were, in this example, not supplied with the data. Only the data itself has been provided, and thus the task of the system is to predict this data-type information based on the data contained in the columns.

Masked language models are a class of language models that are trained on a corpus of data by masking about 10 to 15 percent of words in the input data and predicting the same back. In the process of predicting the masked word back, the model learns to see all the surroundings that are important to predict this word and thus encodes that context in its word embeddings.

In an embodiment, the present invention utilizes an entity-level masked language model 12 as well as a character-level masked language model 14, as shown in FIG. 1. Model 12 is trained to generate embeddings by masking some entities (which may consist of multiple words as in the case of a full name) in the data and predicting them back as in language models. Model 14 is trained with the same approach but at the character level. Here the full entity is masked, then it is predicted back character-by-character and not as the full entity. Embeddings generated through this model will have context at the character level. The result of entity-level model 12 is contextual entity embeddings 16, and the result of character-level model 14 is contextual character embeddings 18.

Masking entities is an improvement over traditional masked language models. Entity-level masking suits this purpose as that is what is intended to be predicted. The rationale behind the character-level model 14 is that tabular data is often filled with proper nouns for, e.g., names of people, places, and the like, which are not available in the vocabulary. Character context in addition to word context helps in determining if the field value is a place name like a city, or a person name, or another type of proper noun, for example.

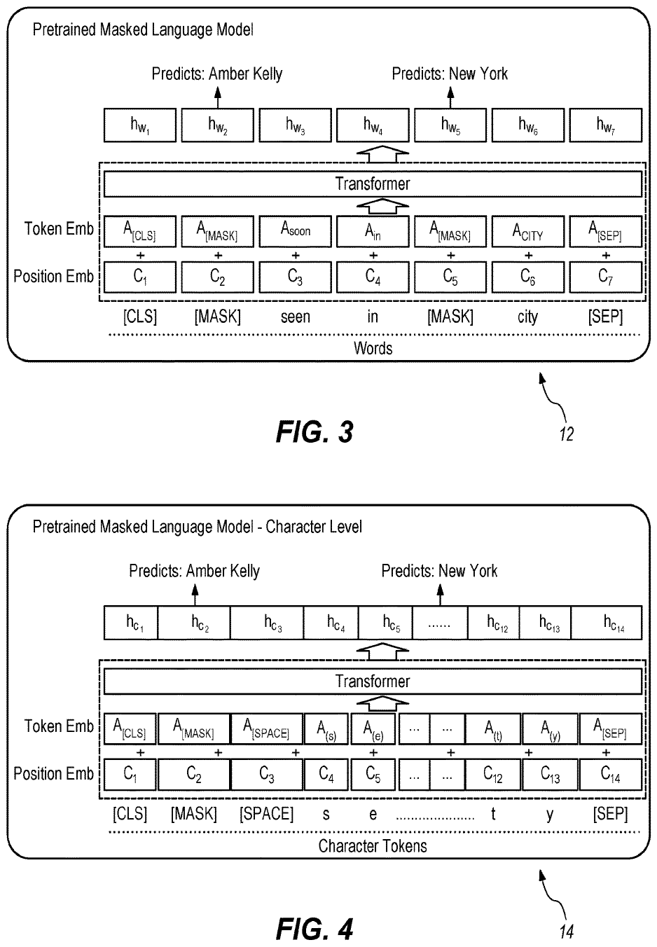

FIGS. 3 and 4 show more detail concerning the operation of entity-level model 12 and character-level model 14. Data for training is sourced from open source locations. It is ensured that the data is diverse in terms of type, number of fields, and a jumbled order of fields, to name a few requirements. Some noise has been introduced so that the output can be immune to different kinds of noise like misspelling, wrongly populated values, such as address fields carrying a person name, etc. The process begins with tokenization of the input, which is performed according to the type of model. Each tokenized input (such as a field in a table) begins with the [CLS] classification token and ends with the [SEP] separator token. The [MASK] token is used to represent the words (in entity-level model 12), or characters (in character-level model 14), that are being masked in a particular case. In the example of FIG. 3, the input sentence for entity-level model 12 is “[MASK]” seen in [MASK] city,” and the input sentence for character-level model 12 is “[MASK] <space> s e . . . t y.” the words or characters to be masked may be selected randomly, for example, based on a total percentage of the words/characters to be used in the model.

When the tokens are prepared, they are presented to the transformer portion of entity-level model 12 and character-level model 14. Transformers are a neural network architecture that improves over recurrent neural networks (RNNs) in terms of long memory, computation time, and better context, and hence transformers facilitate good language models. They excel at self-attention, which allows them to highlight the areas that are important in giving context and ignore other areas. They carry only what is important for purposes of prediction. Self-attention allows the model to draw from the state of any preceding point in the sequence, not simply the last point that was viewed by the model, so that attention weights can dictate how much attention to be provided to each point.

Transformers may undergo unsupervised pre-training followed by supervised fine-tuning for a particular task. The output of the transformer portion of entity-level model 12 is predictive entities in word-level contextual embeddings 16 while the output of character-level model 14 is predictive entities formed character-by-character in character-level contextual embeddings 18. Contextual embeddings are a vector representing semantics of a word or character, which carries context and not simply definitional meaning. Masked language models leverage these transformers to predict masked words/tokens. Entity-level model 12 is such a masked language model. However, the architecture for entity-level model 12 and character-level model 14 is such that, though the masked token is a single token representing multiple words, the model outputs multiple words or one fully entity. It is thus akin to a sentence prediction model.

In the next step, the output of word-level contextual embeddings 16 and character-level contextual embeddings 18 are brought together at merge step 22. At this step, word embeddings and character embeddings are concatenated for each entity. Mean embeddings set 24 is the output of this process. Mean embeddings set 24 is then fed into the neural network classifier 26. The mean embeddings set 24 is computed as the mean of the character-and word-level embeddings, which represents the column fed to the neural network classifier 26. Neural network classifier 26 performs entity typing against this data. Neural networks must be trained, and thus prior to production use neural network classifier 26 is trained using different types of table data. Entity-level model 12 and character-level model 14 are trained with one corpus of data, and these models then output embeddings. A different set of data is taken to generate embeddings using the two language models, and they are used to train classifier 26. Neural network classifier 26 is trained independently of the language models. The output of neural network classifier 26 then is predicted column names 28, which may be appended to table 10 in order to make the columnar data contained in table 20 useful for further production purposes.

Training of the components as described herein may be performed with PyTorch or TensorFlow, for example, in a deep learning framework. PyTorch is an open-source machine learning framework from Meta Al based on the Torch library, whereas TensorFlow is an earlier open-source package developed by Google Brain.

The methods described herein may in various embodiments be implemented by any combination of hardware and software. For example, in one embodiment, the methods may be implemented by a computer system (e.g., a computer system as in FIG. 6) or a collection of computer systems, each of which includes one or more hardware processors executing program instructions stored on a computer-readable physical storage medium coupled to the hardware processors. The program instructions may implement the functionality described herein (e.g., the functionality of various hardware servers and other components that implement the network-based cloud and non-cloud computing resources described herein). The various methods as illustrated in the figures and described herein represent example implementations. The order of any method may be changed, and various elements may be added, modified, or omitted.

FIG. 6 is a block diagram illustrating an example computer hardware system, according to various embodiments. Computer system 500 may implement a hardware portion of a cloud computing system or non-cloud computing system, as forming parts of the various implementations of the present invention. Computer system 500 may be any of various types of hardware devices, including, but not limited to, a commodity server, personal computer system, desktop computer, laptop or notebook computer, mainframe computer system, handheld computer, workstation, network computer, a consumer device, application server, physical storage device, telephone, mobile telephone, or in general any type of computing node, compute node, compute device, and/or hardware computing device.

Computer system 500 includes one or more hardware processors 601a, 601b . . . 601n (any of which may include multiple processing cores, which may be single or multi-threaded) coupled to a physical system memory 602 via an input/output (I/O) interface 604. Computer system 500 further may include a network interface 606 coupled to I/O interface 604. In various embodiments, computer system 500 may be a single processor system including one hardware processor 601a, or a multiprocessor system including multiple hardware processors 601a, 601b . . . 601n as illustrated in FIG. 6. Processors 601a, etc. may be any suitable processors capable of executing computing instructions. For example, in various embodiments, processors 601a, etc. may be general-purpose or embedded processors implementing any of a variety of instruction set architectures. In multiprocessor systems, each of processors 601a, etc. may commonly, but not necessarily, implement the same instruction set. The computer system 500 also includes one or more hardware network communication devices (e.g., network interface 606) for communicating with other systems and/or components over a communications network, such as a local area network, wide area network, or the Internet. For example, a client application executing on system 500 may use network interface 606 to communicate with a server application executing on a single hardware server or on a cluster of hardware servers that implement one or more of the components of the systems described herein in a cloud computing or non-cloud computing environment as implemented in various sub-systems. In another example, an instance of a server application executing on computer system 500 may use network interface 606 to communicate with other instances of an application that may be implemented on other computer systems.

In the illustrated embodiment, computer system 500 also includes one or more physical persistent storage devices 608 and/or one or more I/O devices 610. In various embodiments, persistent storage devices 608 may correspond to disk drives, tape drives, solid-state memory or drives, other mass storage devices, or any other persistent storage devices. Computer system 500 (or a distributed application or operating system operating thereon) may store instructions and/or data in persistent storage devices 608, as desired, and may retrieve the stored instructions and/or data as needed. For example, in some embodiments, computer system 500 may implement one or more nodes of a control plane or control system, and persistent storage 608 may include the solid-state drives (SSDs) attached to that server node. Multiple computer systems 500 may share the same persistent storage devices 608 or may share a pool of persistent storage devices, with the devices in the pool representing the same or different storage technologies, including such technologies as described above.

Computer system 500 includes one or more physical system memories 602 that may store code/instructions 603 and data 605 accessible by processor(s) 601a, etc. The system memories 602 may include multiple levels of memory and memory caches in a system designed to swap information in memories based on access speed, for example. The interleaving and swapping may extend to persistent storage devices 608 in a virtual memory implementation, where memory space is mapped onto the persistent storage devices 608. The technologies used to implement the system memories 602 may include, by way of example, static random-access memory (RAM), dynamic RAM, read-only memory (ROM), non-volatile memory, solid-state memory, or flash-type memory. As with persistent storage devices 608, multiple computer systems 500 may share the same system memories 602 or may share a pool of system memories 602. System memory or memories 602 may contain program instructions 603 that are executable by processor(s) 601a, etc. to implement the routines described herein.

In various embodiments, program instructions 603 may be encoded in binary, Assembly language, any interpreted language such as Java, compiled languages such as C/C++, or in any combination thereof; the particular languages given here are only examples. In some embodiments, program instructions 603 may implement multiple separate clients, server nodes, and/or other components.

In some implementations, program instructions 603 may include instructions executable to implement an operating system (not shown), which may be any of various operating systems, such as UNIX, LINUX, Solaris™, MacOS™, or Microsoft Windows™. Any or all of program instructions 603 may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software or processing application) readable by a machine (e.g., a physical computer). Generally speaking, a non-transitory computer-accessible medium may include computer-readable storage media or memory media such as magnetic or optical media, e.g., disk or DVD/CD-ROM, coupled to or in communication with computer system 500 via I/O interface 604. A non-transitory computer-readable storage medium may also include any volatile or non-volatile media such as RAM or ROM that may be included in some embodiments of computer system 500 as system memory 602 or another type of memory. In other implementations, program instructions may be communicated using optical, acoustical or other form of propagated signals (e.g., carrier waves, infrared signals, digital signals, etc.) conveyed via a communication medium such as a network and/or a wired or wireless link, such as may be implemented via network interface 606. Network interface 606 may be used to interface with other devices 612, which may include other computer systems or any type of external electronic device.

In some embodiments, system memory 602 may include data store 605, as described herein. In general, system memory 602 and persistent storage 608 may be accessible on other devices 602 through a network and may store data blocks, replicas of data blocks, metadata associated with data blocks, and/or their state, database configuration information, and/or any other information usable in implementing the routines described herein.

In one embodiment, I/O interface 604 may coordinate I/O traffic between processors 601a, etc., system memory 602, and any peripheral devices in the system, including through network interface 606 or other peripheral interfaces. In some embodiments, I/O interface 604 may perform any necessary protocol, timing or other data transformations to convert data signals from one component (e.g., system memory 602) into a format suitable for use by another component (e.g., processors 601a, etc.). In some embodiments, I/O interface 604 may include support for devices attached through various types of peripheral buses, such as a variant of the Peripheral Component Interconnect (PCI) bus standard or the Universal Serial Bus (USB) standard, as examples. Also, in some embodiments, some or all of the functionality of I/O interface 604, such as an interface to system memory 602, may be incorporated directly into processor(s) 601a, etc.

Network interface 606 may allow data to be exchanged between computer system 500 and other devices attached to a network, such as other computer systems (which may implement one or more storage system server nodes, primary nodes, read-only node nodes, and/or clients of the database systems described herein), for example. In addition, I/O interface 604 may allow communication between computer system 500 and various I/O devices 610 and/or remote storage 608. Input/output devices 610 may, in some embodiments, include one or more display terminals, keyboards, keypads, touchpads, scanning devices, voice or optical recognition devices, or any other devices suitable for entering or retrieving data by one or more computer systems 500. These may connect directly to a particular computer system 500 or generally connect to multiple computer systems 500 in a cloud computing environment, grid computing environment, or other system involving multiple computer systems 500. Multiple input/output devices 610 may be present in communication with computer system 500 or may be distributed on various nodes of a distributed system that includes computer system 500. In some embodiments, similar input/output devices may be separate from computer system 500 and may interact with one or more nodes of a distributed system that includes computer system 500 through a wired or wireless connection, such as over network interface 106. Network interface 106 may commonly support one or more wireless networking protocols (e.g., Wi-Fi/IEEE 802.11, or another wireless networking standard). Network interface 106 may support communication via any suitable wired or wireless general data networks, such as other types of Ethernet networks, for example. Additionally, network interface 106 may support communication via telecommunications/telephony networks such as analog voice networks or digital fiber communications networks, via storage area networks such as Fibre Channel SANs, or via any other suitable type of network and/or protocol. In various embodiments, computer system 500 may include more, fewer, or different components than those illustrated in FIG. 6 (e.g., displays, video cards, audio cards, peripheral devices, or an Ethernet interface).

Any of the distributed system embodiments described herein, or any of their components, may be implemented as one or more network-based services in the cloud computing environment. For example, a read-write node and/or read-only nodes within the database tier of a hardware database system may present database services and/or other types of physical data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format. Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol. To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a grouping is used herein, all individual members of the group and all combinations and subcombinations possible of the group are intended to be individually included. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A method for automatic semantic data-type detection, comprising the steps of:
receiving a data set in a known data set format, wherein the data set lacks data-type information;
applying an entity masked language model to the data set to create a whole-word contextual embeddings set;
applying a character-by-character masked language model to the data set to create a character-by-character contextual embeddings set;
merging the whole-word contextual embeddings set and character-by-character contextual embeddings data set to create a mean embeddings set; and
applying the mean embeddings set to a neural network classifier to produce a set of predicted data-type information.

2. The method of claim 1, further comprising the step of training the entity masked language model on a textual data set prior to the step of applying the entity masked language model to the data set to create a whole-word contextual embeddings set, and training the character-by-character masked language model on the textual data set prior to the step of applying the character-by-character masked language model to the data set to create a character-by-character contextual embeddings set.

3. The method of claim 2, further comprising the step of training the neural network classifier on a second textual data set prior to the step of applying the mean embeddings set to the neural network classifier to produce the set of predicted data-type information.

4. The method of claim 3, wherein the entity masked language model and the character-by-character masked language model each comprise a transformer configured to perform deep learning natural language processing on the data set.

5. The method of claim 4, further comprising the step of tokenizing the data set by whole words prior to processing the entity masked language model, and tokenizing the data set by characters prior to processing the character-by-character masked language model.

6. The method of claim 5, wherein the data set is columnar data, and the data-type information is column names for the columnar data set.

7. An automatic semantic data-type detection system, comprising:
an entity masked language model;
a character-by-character masked language model;
a neural network classifier;
one or more computer processors; and
a memory space having instructions stored therein, the instructions, when executed by the one or more computer processors, causing the one or more computer processors to:
receive an input data set in a data set format, wherein the data set lacks data-type information;
apply the entity masked language model to the data set to create a whole-word contextual embeddings set;
apply the character-by-character masked language model to the data set to create a character-by-character contextual embeddings set;
merge the whole-word contextual embeddings set and character-by-character contextual embeddings data set to create a mean embeddings set; and
apply the mean embeddings set to the neural network classifier to produce a set of predicted data-type information.

8. The automatic semantic data-type detection system of claim 7, the instructions, when executed by the one or more computer processors, further causing the one or more computer processors to train the entity masked language model on a textual data set prior to the step of applying the entity masked language model to the data set to create a whole-word contextual embeddings set, and training the character-by-character masked language model on the textual data set prior to the step of applying the character-by-character masked language model to the data set to create a character-by-character contextual embeddings set.

9. The automatic semantic data-type detection system of claim 8, the instructions, when executed by the one or more computer processors, further causing the one or more computer processors to train the neural network classifier on a second textual data set prior to the step of applying the mean embeddings set to the neural network classifier to produce the set of predicted data-type information.

10. The automatic semantic data-type detection system of claim 9, wherein the entity masked language model and the character-by-character masked language model each comprise a transformer configured to perform deep learning natural language processing on the data set.

11. The automatic semantic data-type detection system of claim 10, the instructions, when executed by the one or more computer processors, further causing the one or more computer processors to tokenize the data set by whole words prior to processing the entity masked language model, and tokenize the data set by characters prior to processing the character-by-character masked language model.

12. The automatic semantic data-type detection system of claim 11, wherein the data set is columnar data, and the data-type information is column names for the columnar data set.

13. A machine-readable non-transitory physical medium storing machine-readable instructions that, when executed, cause a computer to:
receive a data set in a known data set format, wherein the data set lacks data-type information;
apply an entity masked language model to the data set to create a whole-word contextual embeddings set;
apply a character-by-character masked language model to the data set to create a character-by-character contextual embeddings set;
merge the whole-word contextual embeddings set and character-by-character contextual embeddings data set to create a mean embeddings set; and
apply the mean embeddings set to a neural network classifier to produce a set of predicted data-type information.

14. The machine-readable non-transitory physical medium of claim 13, further storing machine-readable instructions that, when executed, cause the computer to train the entity masked language model on a textual data set prior to applying the entity masked language model to the data set to create a whole-word contextual embeddings set, and to train the character-by-character masked language model on the textual data set prior to applying the character-by-character masked language model to the data set to create a character-by-character contextual embeddings set.

15. The machine-readable non-transitory physical medium of claim 14, further storing machine-readable instructions that, when executed, cause the computer to train the neural network classifier on a second textual data set prior to applying the mean embeddings set to the neural network classifier to produce the set of predicted data-type information.

16. The machine-readable non-transitory physical medium of claim 15, wherein the entity masked language model and the character-by-character masked language model each comprise a transformer configured to perform deep learning natural language processing on the data set.

17. The machine-readable non-transitory physical medium of claim 16, further storing machine-readable instructions that, when executed, cause the computer to tokenize the data set by whole words prior to processing the entity masked language model, and tokenize the data set by characters prior to processing the character-by-character masked language model.

18. The machine-readable non-transitory physical medium of claim 17, wherein the data set is columnar data, and the data-type information is column names for the columnar data set.
